(19) United States
(12) Patent Application Publication
(10) Pub. No.: US 2009/0039728 A1
(43) Pub. Date: Feb. 12, 2009

(54) CONTACT ASSEMBLY

(76) Inventor: PETER J. BALSELLS, Newport Beach, CA (US)

Correspondence Address: WALTER A. HACKLER, 2372 S.E. BRISTOL, SUITE B, NEWPORT BEACH, CA, 92660-0755, US

(21) Appl. No.: 12/244,658

(22) Filed: Oct. 2, 2008

Related U.S. Application Data
(63) Continuation-in-part of application No. 11/113,527, filed on Apr. 25, 2005, now abandoned.
(60) Provisional application No. 60/566,758, filed on Apr. 29, 2004.

(51) Int. Cl. H01R 39/18

(52) U.S. Cl. 310/252

(57) ABSTRACT

A contact assembly for making electrical connection between coaxial members generally includes a rotor having a plurality of spaced apart circumferential electrically conductive rings, and a stator surrounding a rotor with a plurality of spaced apart grooves aligned with the plurality of rings at a variable distance therefrom and enabling continuous, or sustained rotation of the rotor within the stator. A plurality of circular canted-coil springs is provided with each spring being disposed and a corresponding groove providing constant force against a corresponding ring independent of the variable distance between the compression ring and the groove. A plurality of electrical leads is provided with each lead being electrically connected to a corresponding ring.

The present application is a continuation-in-part of U.S. Ser. No. 11/113,527 filed Apr. 25, 2005, now abandoned, which priority from the U.S. Provisional Patent Application, Ser. No. 60/566,758 filed Apr. 29, 2004, which is to be incorporated herein in its entirety including all specification and drawings.

The present invention generally relates to contact assemblies for transferring electrical current between a stationary and a rotor disposed for continuous or sustained rotation within the stationary member. More particularly, the present invention is directed to improved electrical current and electrical signal transfer between a stationary and a continuously rotating body.

In order to provide electrical connection between a stator and a continuous rotating rotor, it has been conventional practice to provide an arrangement of brushes and contact rings, commonly known as slip rings, which are in continuous mutual sliding contact.

There are various types of brushes, for example, cartridge, cantilever, and wire composites, as well as multi-fiber wire and others. All of these brush configurations are characterized by devices that provide an electrical path through a limited portion of a contact face at any given position.

However, difficulties arise in maintaining unnecessary electrical communication due to not only brush and contact during wear, but also due to surface irregularities.

The present invention provides for the utilization of a canted coil spring as the sliding contact with a slip ring which provides for consistent and durable electrical connection.

### SUMMARY OF THE INVENTION

A contact assembly in accordance with the present invention for making electrical connection between coaxial members generally includes a continuously (i.e. sustained) rotating rotor having a plurality of spaced apart circumferential electrically conductive rings along with a stator surrounding the rotor which includes a plurality of spaced apart grooves aligned with the plurality of rings at a variable distance therefrom.

Such variable distance is caused by misalignment due to initial assembly or through wear of the conductive rings.

A plurality of circular canted coil springs is provided with each spring being disposed in a corresponding groove and providing a constant force against the corresponding ring which is independent of the variable distance between the corresponding conductive ring and groove.

In addition, a plurality of leads are provided with each lead being electrically connected to a corresponding spring.

When in place, the coils of the canted-coil spring deflect along a minor axis providing a constant force. This contact force must be low enough to prevent excessive friction between the spring and corresponding ring while at the same time providing adequate force to break any surface film.

A contact coil spring in accordance with the present invention provides a nearly constant force over a wide deflection range greater than the variable distance, thus providing a constant force as wear occurs.

Further, the spring deflection provides a greater tolerance between mating parts since the force/deflection characteristics of the canted-coil spring maintain a nearly constant force as the deflection changes, thus reducing the system sensitivity to surface irregularities.

More particularly, the grooves utilized in accordance with the present invention may include a flat bottom, a V-bottom, or a tapered bottom. Further, the spring may comprise a radial spring or an axial spring. More particularly, the radial spring may include round coils, or elliptical coils, and to maintain the spring and the groove, coils may include a width greater than a corresponding groove width.

### BREIF DESCRIPTION OF THE DRAWINGS

The present invention may be more clearly understood with reference to the following detailed description in conjunction with the appended drawings, of which;

FIGS. 1A and 1B are side and front views of a conventional slip ring assembly that utilizes brushes;

FIG. 2 is a perspective view of a rotor suitable for continuous or sustained rotation within a stator (not shown in FIG. 2) in accordance with the present invention generally including a plurality of spaced apart circumferentially electrically conductive rings;

FIG. 3 is a cross sectional view of a stator for receiving the rotation shown in FIG. 2 and enabling continuous, or sustained, rotation thereof in accordance with the present invention generally showing a plurality of spaced apart grooves for alignment with the conductive rings of the rotor shown in FIG. 2;

FIG. 4 is a cross sectional view of a stator shown in FIG. 3 taken along the line of 4-4;

FIGS. 5A and 5B are plan and cross sectional side views of a radial canted coil spring illustrating compressive forces in accordance with the present invention;

FIGS. 6A, 6B are plan and cross sectional side views of an axial canted coil spring in accordance with the present invention;

FIGS. 7A, 7B, 7C are diagrams of various grooves suitable for the present invention showing a disposition of a radial spring therein; and

FIGS. 8A, 8B, 8C are similar to FIGS. 7A, 7B, 7C but illustrating an axial spring disposed in various grooves suitable for the present invention.

### DETAILED DESCRIPTION

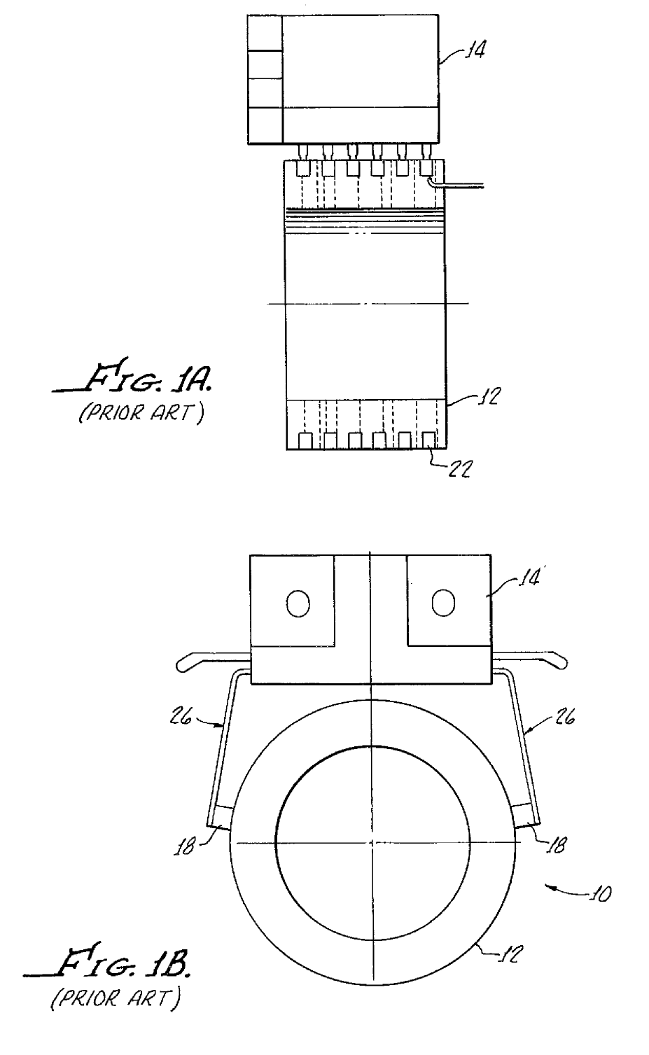

With reference to FIGS. 1A and 1B, there is shown, for comparison purposes, a conventional slip ring assembly 10 including a rotor 12, stator 14, a plurality of brushes, contacting slip rings 22 with the brushes 18 communicating with the stator 14 by means of a cantilever spring 26. As hereinabove noted, irregularities and wear often dictate a limited life of such an assembly.

With reference to FIG. 2, there is shown a rotor 30 in accordance with the present invention which includes a plurality of spaced apart circumferential electrically conductive rings 32 separated by insulating strips 34.

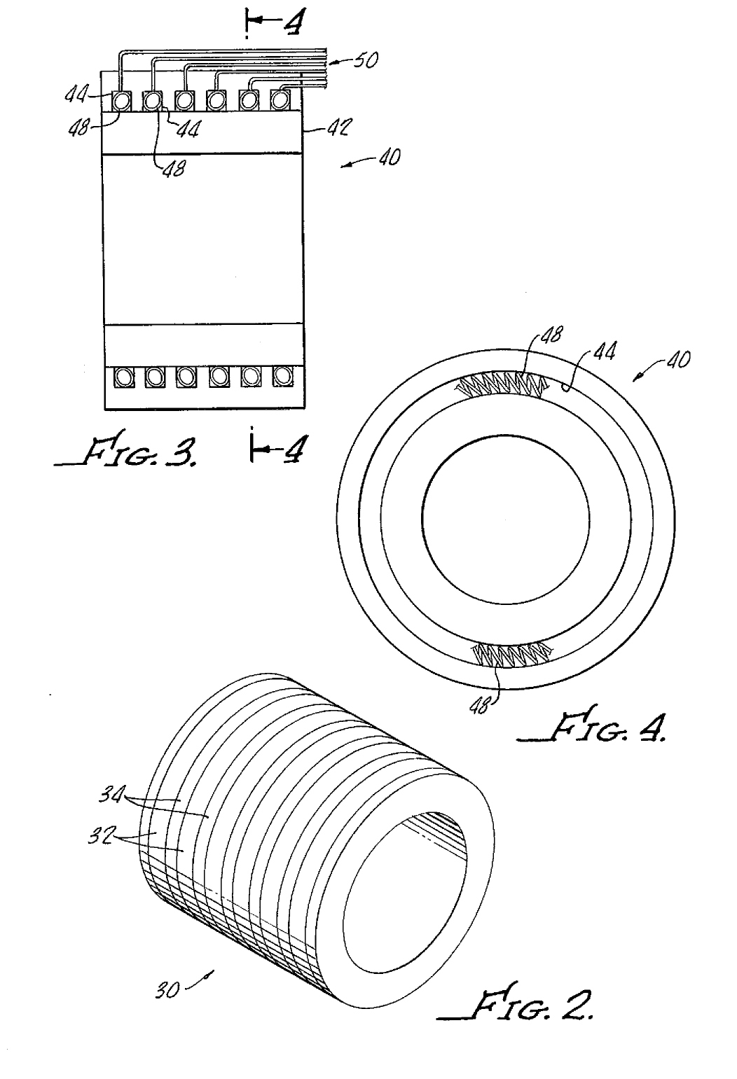

As shown in FIGS. 3 and 4, a stator 40 in accordance with the present invention generally includes a bore 42 therethrough for accepting the rotor 30 and includes a plurality of spaced apart grooves 44 alignable with the conducting rings 32 of the rotor 30 upon assembly.

As shown in FIG. 2, the rotor 30 has no conduits, wires, or cables attached thereto that would prevent continuous, or sustained, rotation of the rotor 30 within the stator 40.

Upon assembly, the grooves 44 are disposed at a variable distance from the strips 32 due to irregularities, manufacturing, tolerances, and wear.

Accordingly, in accordance with the present invention, the circular canted coil springs 48 are configured for providing a constant force against a corresponding ring 32 independent of the variable distance therebetween.

Also shown in FIG. 3 are plurality of leads 50 with each lead 50 being electrically connected to a corresponding spring 48.

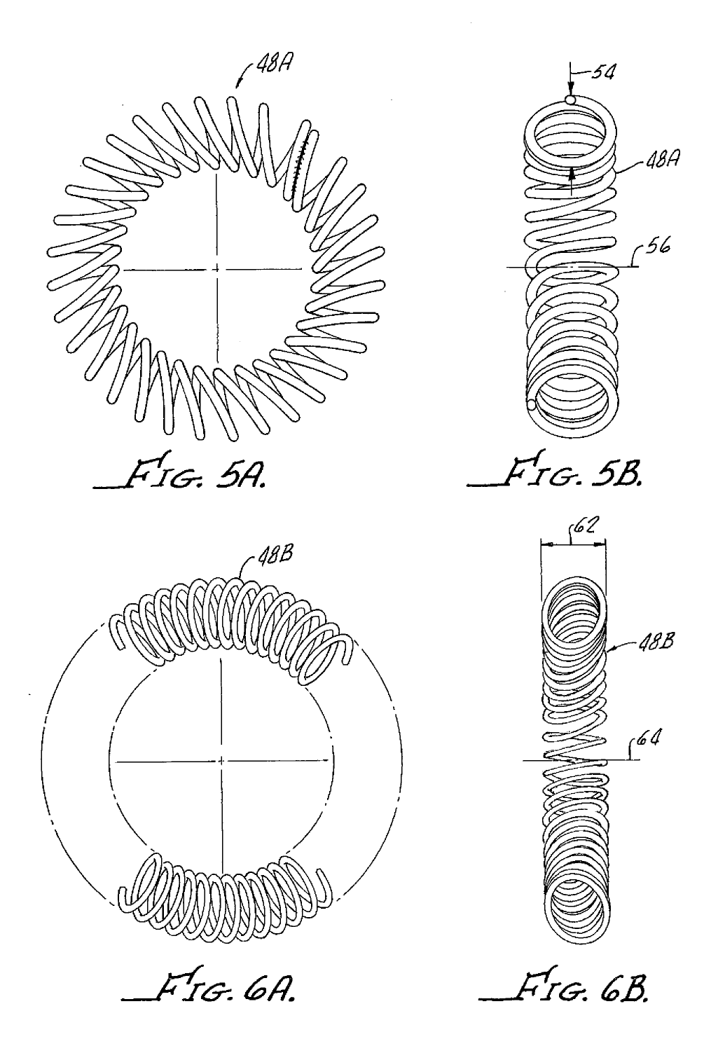

Such springs are may be radial springs 48A, as shown in FIGS. 5A and 5B, or axial springs 48B, as shown in FIGS. 6A and 6B.

The radial spring 48A is one in which the compression force illustrated by the arrow 54 in FIG. 6B is along the radius of the arc perpendicular to the center line 56 shown in FIG. 6B. A radial round spring is one in which the coil height is equal to the coil width.

Briefly illustrated in FIGS. 6A and 6B, is an axial spring 48B and a coil height greater than the coil width in which the compression force shown by the arrow 62 is along the axis 64, as shown in FIG. 6B.

A complete description of suitable springs for use in the present invention may be found in U.S. Pat. Nos. 4,893,795, 4,876,781, 4,974,821, 5,108,078, 5,139,243, 5,139,276, 5,082,390, 5,091,606, 5,411,348, 5,545,842, 5,615,870, 5,709,371, and 5,791,638 all to Balsells. All of these patents are to be incorporated herewith in their entirety including all specification and drawings for the purpose of describing radial and axial circular canted coil springs.

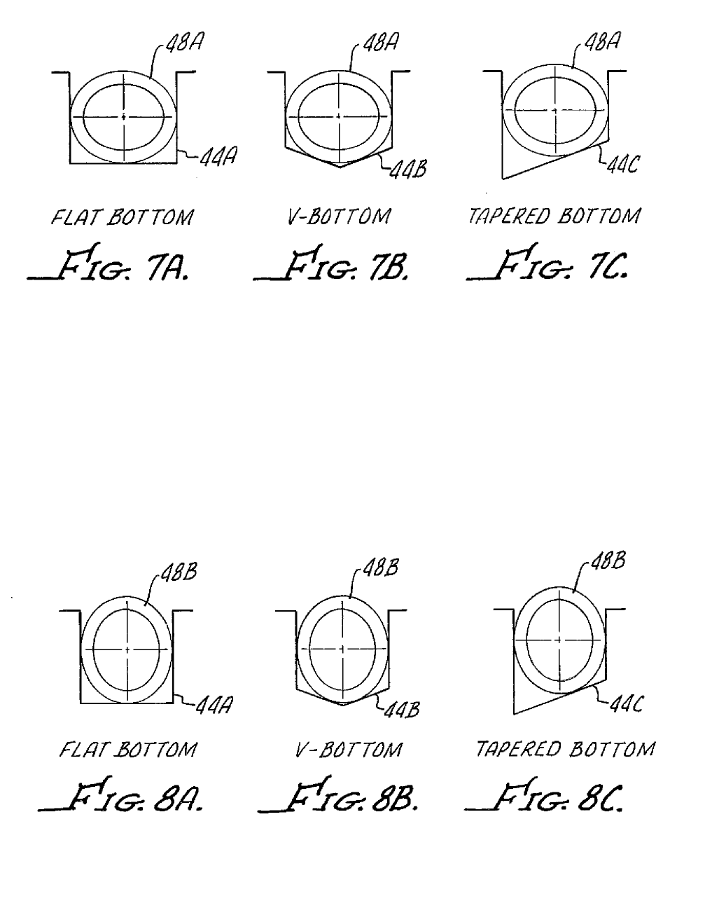

As shown in FIGS. 7A, 7B, 7C for radial spring and FIGS. 8A, 8B, 8C for axial spring 48B, various groove designs may be utilized including flat bottom groove 44A, a V-bottom groove 44B, and a tapered bottom groove 44C.

Although there has been hereinabove described a specific contact assembly in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A contact assembly for making electrical connection between coaxial members, said assembly comprising:
a stator having a plurality of spaced apart circumferential electrically conductive rings;
a rotor disposed within said stator for sustained rotation therein, said rotor having a plurality of spaced apart circumferential electrically conductive rings, the rings beign aligned with the stator grooves at a variable distance therefrom;
a plurality of circular canted coil springs, each spring being disposed in a corresponding groove and providing a constant force against a corresponding ring independent of the variable distance between the corresponding ring and groove; and
a plurality of leads, each lead being electrically connected to a corresponding ring.

2. The assembly according to claim 1 wherein each groove has a flat bottom.

3. The assembly according to claim 1 wherein each groove has a V-bottom.

4. The assembly according to claim 1 wherein each groove has a tapered bottom.

5. The assembly according to claim 1 wherein each spring comprises a radial spring.

6. The assembly according to claim 2 wherein each spring comprises round coils.

7. The assembly according to claim 2 wherein each spring comprises elliptical coils.

8. The assembly according to claim 1 wherein each spring comprises an axial spring.

9. The assembly according to claim 1 wherein each spring has a coil width greater than a corresponding groove width in order to prevent each spring from turning in the corresponding groove.
